(19) United States
(12) Patent Application Publication
(10) Pub. No.: US 2002/0021849 A1
(43) Pub. Date: Feb. 21, 2002

(54) Self-aligning spherical bearing assembly

(76) Inventor: Kenneth N. Whaley, Franklin, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 09/929,133

(22) Filed: Aug. 14, 2001

Related U.S. Application Data
(60) Provisional application No. 60/226,309, filed on Aug. 21, 2000.

(51) Int. Cl. F16C 23/04

(52) U.S. Cl. 384/206

(57) ABSTRACT

A self-aligning spherical bearing assembly for a gear motor that reduces the noise generated by the motor and allows the bearing assembly to self-align at low motor torque levels. The self-aligning bearing assembly includes a seat member that receives a metallic bearing. The seat member is formed from a plastic material, such as Teflon®, to enhance the rotation between the bearing and the seat member. The seat member is received within a thermoplastic barrier member that is positioned between the seat member and the metallic motor housing. The barrier member reduces both vibration and noise generated by the motor.

### CROSS REFERENCE TO RELATED APPLICATION

The present invention is based on and claims priority to U.S. Provisional Application No. 60/226,309, filed on Aug.21, 2000.

### BACKGROUND OF THE INVENTION

The present invention relates generally to a self-aligning spherical bearing assembly. More specifically, the present invention relates to a bearing assembly for use with gear motors that allows for self-aligning at low motor torque levels and provides a reduction in noise levels that are induced by the vibration of the motor rotor.

Many of the small sub-fractional gear motors presently available utilize a self-aligning spherical bearing assembly to support the motor rotor shaft on each end. Although these self-aligning spherical bearing systems have been in use for a long time, one problem commonly encountered with these types of motors is the alignment of the bearing and rotor shaft. The problem referred to typically occurs when the small sub-fractional motors are not able to provide enough start up torque to overcome the static resistance of non-aligned bearings. Thus, during start up of a motor that has become slightly misaligned, the motor may not generate enough torque to begin rotation of the rotor and the motor will then be stalled.

Presently, in order to overcome this condition, it is necessary to tap the end of the rotor shaft and/or bearing bracket to start the motor. Clearly, requiring an owner/operator to tap the motor to begin operation is an undesirable situation.

Additionally, anytime the motor is jarred, the process may need to be repeated due to misalignment of the bearings. Again, requiring the owner/operator of the motor to physically tap the motor to begin operation is an undesirable operating condition.

In addition to the alignment problems identified above, currently available self-aligning bearing assemblies produce noise at excessive levels. The noise problem is brought on by the unbalanced condition of the rotor combined with the electromagnetic field of the motor to produce radial vibrations that are transferred to the gear case and motor lamination stack, thus producing high noise levels.

Therefore, a need exists for a bearing assembly that will self-align at low motor torque levels. Further, a need exists for a bearing assembly that reduces the noise levels produced by the assembly during operation.

### SUMMARY OF THE INVENTION

It is an object of the present invention to provide a self-alignment bearing system that will self-align at low motor torque levels. Still another object of the present invention is to provide a bearing assembly that decreases the level of noise produced by the motor assembly.

In accordance with the present invention, a bearing assembly is provided that includes a self-aligning spherical bearing system. The self-aligning system includes a Teflon® or plastic seat member that receives the metallic bearing that is slip fit onto the rotor shaft. The Teflon® or plastic seat member is in rotational contact with the bearing and includes a tapered inner wall generally corresponding to the curved outer surface of the bearing. Thus, the interaction between the seat member and the bearing allows the bearing to rock back and forth within the seat member.

The seat member in turn is received within a barrier member formed from a thermoplastic elastomer. The barrier member is positioned between the seat and metallic gear case. The physical characteristics of the barrier member reduce the noise created by the rotating rotor shaft and absorbs vibrations resulting from the rotation of the rotor shaft.

The combination of the Teflon( seat member and the thermoplastic elastomer barrier member allow the bearing assembly to self-align at low motor torque levels and reduces the noise and vibration created by the gear motor.

The self-aligning bearing assembly of the present invention further includes an oil ring positioned to surround at least a portion of the bearing. The oil ring is impregnated with lubricating oil to reduce the friction generated between the rotating shaft and the bearing. A spring retainer is positioning in contact with the oil ring and surrounds the bearing to hold the seat member, the barrier and the oil ring in place within the gear case or/and housing.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a partial section view of a sub-fractional gear motor incorporating the self-aligning spherical bearing assembly constructed in accordance with the present invention;

FIG. 2 is an exploded view of the self-aligning spherical bearing assembly positioned between the rotor shaft and the gear case as shown in FIG. 1;

FIG. 3 is a section view of the end housing bearing assembly in its assembled condition; and

FIG. 4 is an exploded view of the end housing bearing assembly of FIG. 3.

### DETAILED DESCRIPTION OF THE INVENTION

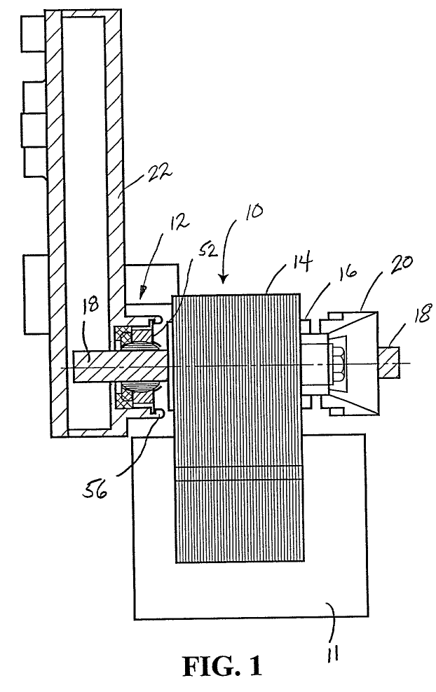

Referring first to FIG. 1, thereshown is a small sub-fractional gear motor 10 that includes the self-aligning spherical bearing assembly 12 constructed in accordance with the present invention. The gear motor 10 generally includes a motor winding 11 and a stator lamination stack 14 that surrounds a rotor 16 including a rotor shaft 18. The rotor shaft 18 is supported at a first end by an end housing 20 including a bearing assembly and is supported at a second end by the bearing assembly 12 contained in the gear case 22.

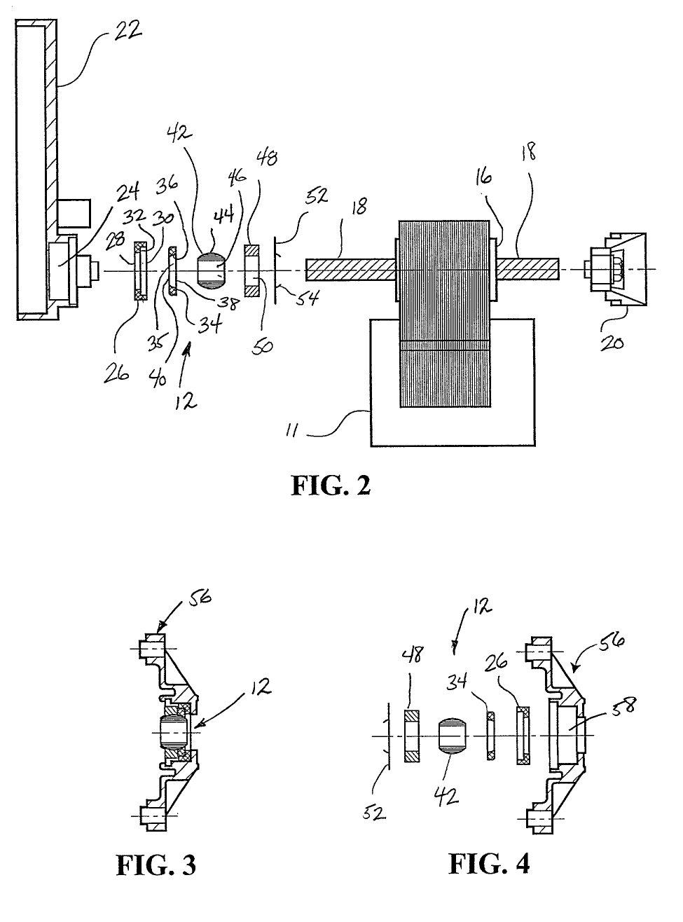

Referring now to FIG. 2, the bearing assembly 12 used to rotatably support the second end of the rotor shaft 18 within the gear case 22 is shown in an exploded view. The bearing assembly 12 is contained within a bearing receptacle 24 formed in the gear case 22, as can be seen in FIG. 1.

Referring back to FIG. 2, the bearing assembly 12 generally includes a barrier member 26 having an outer diameter that corresponds with the inner diameter of the bearing receptacle 24 such that the barrier member 26 securely fits within the bearing receptacle 24. The barrier member 26 is a circular ring-like member having a first aperture 28 and a second aperture 30 that are coaxial with each other. The first aperture 28 has a depth of approximately one-half the thickness of the barrier member 26 and has an inner diameter greater than the outer diameter of the rotor shaft 18 and bearing 42. Thus, the rotor shaft 18 and bearing 42 are freely rotatable within the barrier member 26. The second aperture 30 of the barrier member 26 also has a depth of approximately one half the thickness of the barrier member 26 and has an inner diameter slightly greater than the diameter of the first aperture 28. Thus, the difference in diameter between the second aperture 30 and the first aperture 28 creates a shoulder 32.

In the preferred embodiment of the invention, the barrier member 26 is formed from a thermoplastic elastomer, although other equivalent materials can be used. The thermoplastic elastomer used to form the barrier member 26 both absorbs the vibrations created by an unbalanced bearing assembly and cushions the contact between the gear case 22 and the bearing assembly 12. In this manner, the barrier member 26 reduces the noise created by operation of the gear motor.

As can be seen in FIGS. 1 and 2, a seat member 34 is received within the second aperture 30 of the barrier 26 and contacts the shoulder 32. The seat 34 is a ring-shaped member having a central opening 35 defined by a tapered inner wall 36. The central opening 35 decreases in diameter from a first side 38 of the seat member to a second end 40 of the seat member. In the preferred embodiment of the invention, the seat member 34 is formed from Teflon*. However, it is contemplated by the inventor that the seat member 34 could be formed from any other equivalent material having a low coefficient of friction.

As can be seen in FIG. 2, the seat member 34 receives the metallic bearing 42. The bearing 42 includes a curved outer surface 44 and a central bore 46. The central bore 46 is sized to be slip fit onto the rotor shaft 18, as illustrated in FIG. 1, as the rotor shaft 18 rotates in the central bore 46.

The conventional bearing 42 is formed from bronze and allows the rotor shaft 18 to rotate relative to the stationary gear case 22. The curved outer surface 44 of the bearing 42 allows the bearing 42 to rock back and forth in the seat member 34 to allow the bearing assembly 12 to compensate for slight variations in the movement of the rotor shaft 18 relative to the gear case 22.

In previously available bearing assemblies, the bearing 42 was seated against a metal seat formed in the gear case 22 such that the rotor shaft 18 was rotatable relative to the gear case 22. However, the metal on metal contact between the bearing and the gear case often prevented rotation between the rotor shaft 18 and the gear case 22 when the bearing became misaligned, particularly in motors that generate low torque. In accordance with the present invention, the Teflon® seat member 34 creates a smooth, non-binding surface that allows the rotor shaft 18 to rotate even after the bearing 42 becomes misaligned.

The bearing assembly 12 further includes an oil ring 48 that is positioned in contact with the bearing 42. The oil ring 48 includes a central opening 50 sized to surround and contact the bearing 42 such that the bearing 42 and the rotor shaft 18 are freely rotatable within the oil ring 48. The oil ring 48 is a convention component of bearing assemblies and is typically formed from an oil-impregnated felt material. The oil ring 48 thus lubricates the bearing 42 during operation of the motor.

Finally, the bearing assembly 12 includes a spring retainer 52 having a series of tabs 54 that retain the bearing 42 within the bearing receptacle 24, as best seen in FIGS. 1 and 2. The spring retainer 52 is secured beneath a lip 56, as shown in FIG. 1, to securely hold the retainer 52 in place.

In addition to the first bearing assembly 12 positioned between the rotor shaft 18 and the gear case 22, a second bearing assembly is contained within the end housing 20 to support the opposite end of the rotor shaft 18. Referring now to FIG. 3, thereshown is the bearing assembly 12 positioned within the end housing support assembly 56. As can best be seen in FIG. 4, the support assembly 56 includes a bearing receptacle 58 that receives the combination of the barrier member 26, seat member 34, bearing 42, oil ring 48 and spring retainer 52. The bearing assembly 12 between the rotor shaft 18 and the end housing 20 is identical to the first bearing assembly illustrated in FIG. 2. Thus, the combination of the two bearing assemblies provide a self-aligning bearing system to rotatably support the rotor shaft 18, which allow the rotor to self-align at low motor torque levels and reduces noise levels generated by the motor.

Various alternatives and embodiments are contemplated as being within the scope of the following claims particularly pointing out and distinctly claiming the subject matter regarded as the invention.

I claim:

1. A self-aligning bearing assembly positionable between a rotor shaft and a bearing receptacle of a stationary support housing, the bearing assembly comprising:
a spherical bearing positionable along the rotor shaft, the spherical bearing including a curved outer surface; and
a seat member positionable within the bearing receptacle of the support housing, the seat member including central opening sized to receive the bearing, wherein the seat member contacts and supports the bearing during rotation of the rotor shaft.

2. The bearing assembly of claim 1 wherein the seat member includes a tapered inner wall that defines the central opening, wherein the tapered inner wall contacts the curved outer surface of the bearing to align the bearing and the rotor shaft relative to the support housing.

3. The bearing assembly of claim 1 wherein the seat member is formed from a low friction plastic material.

4. The bearing assembly of claim 3 wherein the seat member is formed of Teflon®.

5. The bearing assembly of claim 1 further comprising an oil ring positionable to surround the bearing, wherein the oil ring provides lubrication for the rotation of the bearing relative to the seat member.

6. The bearing assembly of claim 5 further comprising a spring retainer positioned to contact the oil ring and bearing to hold the bearing assembly within the bearing receptacle of the stationary support housing.

7. The self-aligning bearing assembly positionable between a rotor shaft and a bearing receptacle of a stationary support housing, a bearing assembly comprising:
a spherical bearing positionable along the rotor shaft, the spherical bearing including a curved outer surface;
a barrier member positionable within the bearing receptacle of the support housing, the barrier member being configured to allow the rotor shaft to pass freely there through; and
a seat member disposed within the barrier member, the seat member including a central opening sized to receive the bearing, wherein the seat member contacts and supports the bearing during rotation of the rotor shaft.

8. The bearing assembly of claim 7 wherein the barrier member is formed from a thermoplastic elastomer.

9. The bearing assembly of claim 8 wherein the barrier member includes an aperture extending into the barrier member and terminating at an internal circular shoulder, wherein the seat member is positioned in contact with the shoulder formed in the seat member.

10. The bearing assembly of claim 7 wherein the seat member includes a tapered inner wall that defines the central opening, wherein the tapered inner wall contacts the curved outer surface of the bearing to align the bearing and rotor shaft relative support housing.

11. The bearing assembly of claim 10 wherein the seat member is formed from a low friction plastic material.

12. The bearing assembly of claim 11 wherein the seat member is formed of Teflon®.

13. The bearing assembly of claim 7 further comprising an oil ring positionable to surround the bearing, wherein the oil ring provides lubrication for the rotation of the bearing relative to the seat member and the shaft.

14. The bearing assembly of claim 13 further comprising a spring retainer positioned to contact the oil ring and bearing to hold the bearing assembly within the bearing receptacle of the stationary support housing and limit rotation of the bearing in the bearing receptacle.

15. A self-aligning bearing assembly positionable between a rotor shaft and a bearing receptacle of a stationary support housing, the bearing assembly comprising:
a spherical bearing positionable along the rotor shaft, the spherical bearing including a curved outer surface;
a barrier member positionable within the support housing, a barrier member being formed from a thermoplastic elastomer and having an aperture extending into the barrier member and terminating at a shoulder;
a seat member disposed within the barrier member, the seat member being in contact with the shoulder formed in the seat member, the seat member including a central opening sized to receive the bearing, wherein the seat member contacts and supports the bearing during rotation of the shaft, wherein the seat member is formed from a low friction plastic material;
an oil ring positioned to surround and contact the bearing, the oil ring providing lubrication for the rotation of the bearing relative to the seat member and shaft; and
a spring retainer positioned to hold the bearing and the oil ring within the bearing receptacle of the support housing and limit the bearing rotation.

16. The bearing assembly of claim 15 wherein the seat member is formed of Teflon®.
